(19) United States
(12) Patent Application Publication
(10) Pub. No.: US 2007/0181634 A1
(43) Pub. Date: Aug. 9, 2007

(54) WAVE SOLDER APPARATUS

(75) Inventors: Wen-Chi Chen, Kuei Shan Hsiang (TW); Jauwhei Hong, Kuei Shan Hsiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc., Tao Yuan Shien (TW)

(21) Appl. No.: 11/380,221

(22) Filed: Apr. 26, 2006

(30) Foreign Application Priority Data
Feb. 3, 2006 (TW) 95103761

(51) Int. Cl. B23K 1/08

(52) U.S. Cl. 228/37; 228/36; 228/9

(57) ABSTRACT

A wave solder apparatus. A conveyer carries a circuit board. A solder tank is disposed under the conveyer and includes a turbulent nozzle and a laminar nozzle separated therefrom by a predetermined distance. A first heater is disposed under the conveyer and adjacent to the solder tank, heating the bottom surface of the circuit board. A second heater is disposed above the conveyer and opposes the first heater, heating the top surface of the circuit board. A third heater is disposed above the conveyer and opposes the turbulent and laminar nozzles of the solder tank, heating the top surface of the circuit board.

### BACKGROUND OF THE INVENTION

1. Field of the Invention

The invention relates to a wave solder apparatus, and in particular to a wave solder apparatus for a lead-free wave solder process.

2. Description of the Related Art

In a conventional wave solder process, molten solder is filled in through holes of a printed circuit board (PCB), connecting pins, disposed in the through holes, of an electronic member to the PCB.

Generally, the molten solder in a solder tank is output to the through holes containing the pins of the electronic member from the bottom side of the PCB using a turbulent wave, filling in the through holes and covering the pins. The molten solder in the solder tank is then output to the bottom surface of the PCB using a laminar wave, removing redundant solder therefrom. Short circuit between the pins is thus prevented.

Moreover, compared to lead-free solder, leaded solder provides a low melting point and high surface tension. When output to the through holes of the PCB using the turbulent wave, the leaded solder is easily filled therein. The melting point of the lead-free solder, such as SAC (Sn/Ag/Cu) alloy, is often between 217° C. and 220° C. The melting point of the leaded solder is about 183° C. The surface tension of the leaded solder is higher than that of the lead-free solder. Accordingly, the leaded solder does not easily solidify on the bottom surface of the PCB and form solder bridges, which results in short circuit, between the pins of the electronic member. Namely, the molten leaded solder output to the bottom surface of the PCB using the laminar wave can easily remove the redundant leaded solder.

For environmental consideration, lead-free solder is commonly used. The lead-free solder with a high melting point (217° C.-220° C.), however, causes some problems in the wave solder process.

Referring to FIG. 1, a conventional wave solder device 1 comprises a conveyer 11, a solder tank 12, a first heater 13. and a second heater 14. The conveyer 11 transports printed circuit boards P. The solder tank 12 is disposed under the conveyer 11 and contains molten lead-free solder. Additionally, the solder tank 12 comprises a turbulent nozzle 12a and a laminar nozzle 12b. The first heater 13 and second heater 14 are disposed beside the solder tank 12 and respectively above and under the conveyer 11.

When transported in a direction A shown in FIG. 1 by the conveyer 11, the printed circuit boards P are heated by the first heater 13 and second heater 14 in advance, having specific temperatures on the top and bottom surfaces thereof. When the printed circuit board P is transported to the top of the solder tank 12, the turbulent nozzle 12a upwardly outputs the molten lead-free solder in a direction B shown in FIG. 1 to through holes P1 (FIG. 2), containing pins E of electronic members, of the printed circuit board P. The laminar nozzle 12b then outputs the molten lead-free solder in a direction C shown in FIG. 1 to the bottom surface of the printed circuit board P, removing redundant lead-free solder therefrom.

As shown in FIG. 2, having a high melting point, the lead-free solder S often solidifies before thoroughly filling in the through holes P1, thus not complying with regulations of through hole solder fill of the IPC standard, which asserts that solder must occupy at least 75% space of a through hole. Meanwhile, the redundant lead-free solder S solidifies on the lower portions of the pins E of the electronic members. The printed circuit board P is then transported to allow the through holes P1 thereof to be above the laminar nozzle 12b. As the temperature of the bottom surface of the printed circuit board P is reduced, the melting point of the lead-free solder is higher, and the surface tension of the lead-free solder is smaller, the molten lead-free solder output by the laminar nozzle 12b cannot remove the redundant lead-free solder S, of the printed circuit board P. Accordingly, short circuit between the pins E is generated.

Hence, there is a need for an improved wave solder apparatus for a lead-free wave solder process, thoroughly filling lead-free solder in through holes of a printed circuit board and effectively preventing formation of short circuit thereon.

### BRIEF SUMMARY OF THE INVENTION

A detailed description is given in the following embodiments with reference to the accompanying drawings.

An exemplary embodiment of the invention provides a wave solder apparatus comprising a conveyer, a solder tank, a first heater, a second heater, and a third heater. The conveyer carries a circuit board. The solder tank is disposed under the conveyer and comprises a turbulent nozzle and a laminar nozzle separated therefrom by a predetermined distance. The first heater is disposed under the conveyer and adjacent to the solder tank, heating the bottom surface of the circuit board. The second heater is disposed above the conveyer and opposes the first heater, heating the top surface of the circuit board. The third heater is disposed above the conveyer and opposes the turbulent and laminar nozzles of the solder tank, heating the top surface of the circuit board.

The wave solder apparatus further comprises a fourth heater disposed under the conveyer and between the turbulent nozzle and the laminar nozzle, heating the bottom surface of the circuit board.

The third heater comprises a first temperature detection and control member opposing the top surface of the circuit board. The first temperature detection and control member detects and controls the temperature of the top surface of the circuit board.

The first temperature detection and control member detects the temperature of the top surface of the circuit board and controls the third heater, maintaining the temperature thereof between 120° C. and 197° C.

The fourth heater comprises a second temperature detection and control member opposing the bottom surface of the circuit board. The second temperature detection and control member detects and controls the temperature of the bottom surface of the circuit board.

The second temperature detection and control member detects the temperature of the bottom surface of the circuit board and controls the fourth heater, maintaining the temperature thereof above 180° C.

### BRIEF DESCRIPTION OF THE DRAWINGS

The invention can be more fully understood by reading the subsequent detailed description and examples with references made to the accompanying drawings, wherein:

FIG. 1 is a schematic side view of a conventional wave solder device;

FIG. 2 is a schematic view showing soldering, produced by the conventional wave solder device of FIG. 1, between a printed circuit board and pins of electronic members;

FIG. 3 is a schematic side view of a wave solder apparatus of the invention; and

FIG. 4 is a schematic view showing soldering, produced by the wave solder apparatus of the invention, between a circuit board and pins of an electronic member.

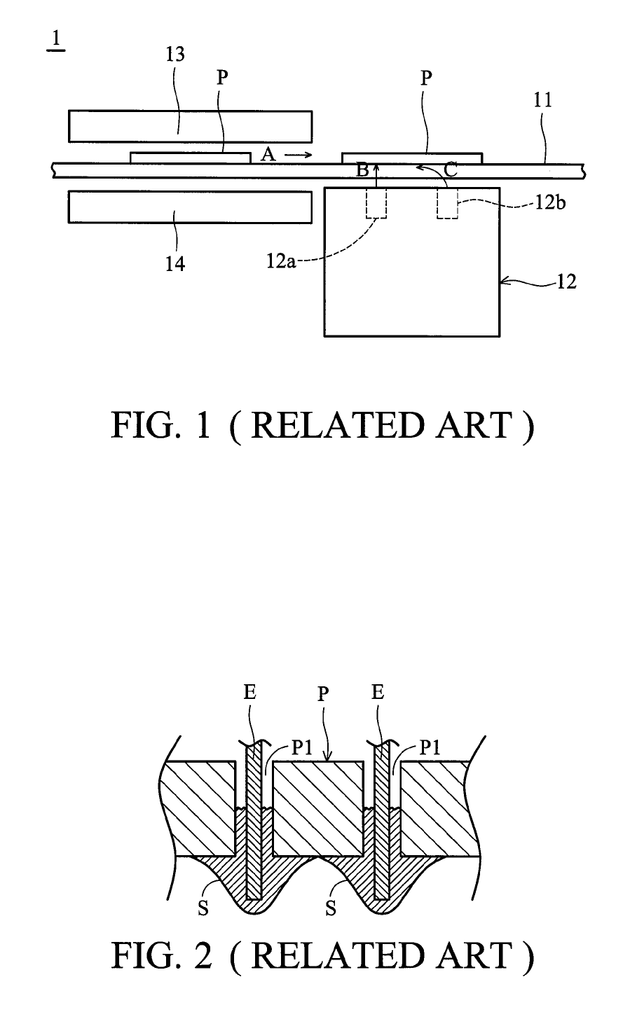

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

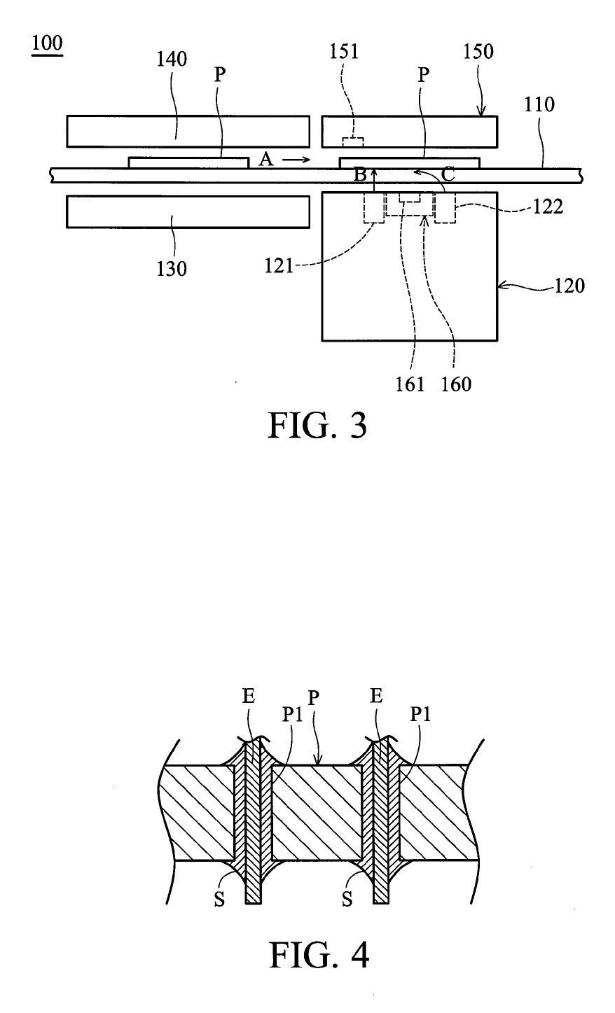

Referring to FIG. 3, a wave solder apparatus 100 comprises a conveyer 110, a solder tank 120, a first heater 130, a second heater 140, a third heater 150, and a fourth heater 160.

The conveyer 110 carries circuit boards P. As shown in FIG. 4, each circuit board P has a plurality of through holes P1, in which pins E of an electronic member respectively fit.

As shown in FIG. 3, the solder tank 120 is disposed under the conveyer 110 and contains molten lead-free solder. Additionally, the solder tank 120 comprises a turbulent nozzle 121 and a laminar nozzle 122 separated therefrom by a predetermined distance.

The first heater 130 is disposed under the conveyer 110 and adjacent to the solder tank 120, heating the bottom surface of the circuit board P.

The second heater 140 is disposed above the conveyer 110 and opposes the first heater 130, heating the top surface of the circuit board P.

The third heater 150 is disposed above the conveyer 110 and opposes the turbulent nozzle 121 and laminar nozzle 122 of the solder tank 120, heating the top surface of the circuit board P. Additionally, the third heater 150 comprises a first temperature detection and control member 151 opposing the top surface of the circuit board P.

The fourth heater 160 is disposed under the conveyer 110 and between the turbulent nozzle 121 and the laminar nozzle 122, heating the bottom surface of the circuit board P. Additionally, the fourth heater 160 comprises a second temperature detection and control member 161 opposing the bottom surface of the circuit board P.

When transported in a direction A shown in FIG. 3 by the conveyer 110, the circuit board P is heated by the first heater 130 and second heater 140 in advance, having specific temperatures on the top and bottom surfaces thereof. When the circuit board P is transported to the top of the solder tank 120, the third heater 150 heats the top surface of the circuit board P. Meanwhile, the first temperature detection and control member 151 detects the temperature of the top surface of the circuit board P and controls the third heater 150, maintaining the temperature thereof within a specific range, such as between 120° C. and 197° C. Specifically, the temperature of the top surface of the circuit board P is maintained below 197° C., such that damage to other electronic elements disposed thereon is prevented. In another aspect, the fourth heater 160 heats the bottom surface of the circuit board P. Meanwhile, the second temperature detection and control member 161 detects the temperature of the bottom surface of the circuit board P and controls the fourth heater 160, maintaining the temperature thereof above 180° C. Accordingly, the molten lead-free solder in the solder tank 120 is upwardly output to the through holes P1 containing the pins E of the electronic member in a direction B shown in FIG. 3 by the turbulent nozzle 121. As the temperature of the bottom surface of the circuit board P is maintained above 180° C. by the fourth heater 160 and that of the top surface thereof maintained between 120° C. and 197° C. by the third heater 150, the molten lead-free solder does not solidify, thus upwardly and thoroughly filling in the through holes P1, as shown by lead-free solder S of FIG. 4. In another aspect, the molten lead-free solder in the solder tank 120 is output to the bottom surface of the circuit board P in a direction C shown in FIG. 3 by the laminar nozzle 122. As the temperature of the bottom surface of the circuit board P is still maintained above 180° C. by the fourth heater 160, the molten lead-free solder output to the bottom surface thereof not solidify, thus removing the redundant lead-free solder from the bottom surface thereof. Short circuit between the pins E of the electronic member is thus prevented.

Moreover, although utilizing the third and fourth heaters to perform the aforementioned lead-free wave solder process, the disclosed wave solder apparatus is not limited to simultaneously having the third and fourth heaters. Namely, the wave solder apparatus may utilize only a third or fourth heater to perform the lead-free wave solder process.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wave solder apparatus, comprising:
a conveyer carrying a circuit board;
a solder tank disposed under the conveyer and comprising a turbulent nozzle and a laminar nozzle separated therefrom by a predetermined distance;
a first heater disposed under the conveyer and adjacent to the solder tank, heating the bottom surface of the circuit board;
a second heater disposed above the conveyer and opposing the first heater, heating the top surface of the circuit board; and
a third heater disposed above the conveyer and opposing the turbulent and laminar nozzles of the solder tank, heating the top surface of the circuit board.

2. The wave solder apparatus as claimed in claim 1, further comprising a fourth heater disposed under the conveyer and between the turbulent nozzle and the laminar nozzle, heating the bottom surface of the circuit board.

3. The wave solder apparatus as claimed in claim 1, wherein the third heater comprises a first temperature detection and control member opposing the top surface of the circuit board, and the first temperature detection and control member detects and controls the temperature of the top surface of the circuit board.

4. The wave solder apparatus as claimed in claim 3, wherein the first temperature detection and control member detects the temperature of the top surface of the circuit board and controls the third heater, maintaining the temperature thereof between 120° C. and 197° C.

5. The wave solder apparatus as claimed in claim 2, wherein the fourth heater comprises a second temperature detection and control member opposing the bottom surface of the circuit board, and the second temperature detection and control member detects and controls the temperature of the bottom surface of the circuit board.

6. The wave solder apparatus as claimed in claim 5, wherein the second temperature detection and control member detects the temperature of the bottom surface of the circuit board and controls the fourth heater, maintaining the temperature thereof above 180° C.

7. A wave solder apparatus, comprising:
a conveyer carrying a circuit board;
a solder tank disposed under the conveyer and comprising a turbulent nozzle and a laminar nozzle separated therefrom by a predetermined distance;
a first heater disposed under the conveyer and adjacent to the solder tank, heating the bottom surface of the circuit board;
a second heater disposed above the conveyer and opposing the first heater, heating the top surface of the circuit board; and
a third heater disposed under the conveyer and between the turbulent nozzle and the laminar nozzle, heating the bottom surface of the circuit board.

8. The wave solder apparatus as claimed in claim 7, further comprising a fourth heater disposed above the conveyer and opposing the turbulent and laminar nozzles of the solder tank, heating the top surface of the circuit board.

9. The wave solder apparatus as claimed in claim 7, wherein the third heater comprises a first temperature detection and control member opposing the bottom surface of the circuit board, and the first temperature detection and control member detects and controls the temperature of the bottom surface of the circuit board.

10. The wave solder apparatus as claimed in claim 9, wherein the first temperature detection and control member detects the temperature of the bottom surface of the circuit board and controls the third heater, maintaining the temperature thereof above 180° C.

11. The wave solder apparatus as claimed in claim 8, wherein the fourth heater comprises a second temperature detection and control member opposing the top surface of the circuit board, and the second temperature detection and control member detects and controls the temperature of the top surface of the circuit board.

12. The wave solder apparatus as claimed in claim 11, wherein the second temperature detection and control member detects the temperature of the top surface of the circuit board and controls the fourth heater, maintaining the temperature thereof between 120° C. and 197° C.
